(19) United States
(12) Patent Application Publication
(10) Pub. No.: US 2022/0080709 A1
(43) Pub. Date: Mar. 17, 2022

(54) MULTILAYER STRUCTURES, PROCESSES FOR MANUFACTURING MULTILAYER STRUCTURES, AND RELATED ARTICLES

(71) Applicants: Dow Global Technologies LLC, Midland, MI (US); Performance Materials NA, Inc., Midland, MI (US)

(72) Inventors: Jianping Pan, Shanghai (CN); Luis Duque, Tarragona (ES); Karlheinz Hausmann, Auvernier (CH); Barry Alan Morris, Wilmington, DE (US); Thomas Galatik, Richterswil (CH)

(73) Assignees: Dow Global Technologies LLC, Midland, MI (US); Performance Materials NA, Inc., Midland, MI (US)

(21) Appl. No.: 17/421,160

(22) PCT Filed: Jan. 21, 2020
(86) PCT No.: PCT/US2020/014316

§ 371 Date: Jul. 7, 2021

Related U.S. Application Data
(60) Provisional application No. 62/799,251, filed on Jan. 31, 2019.

(51) Int. Cl. B32B 27/08; B32B 27/32; B32B 27/36; C08L 23/06

(52) U.S. Cl. CPC B32B 27/08; B32B 27/32; B32B 27/36; C08L 23/06; B32B 2255/10; B32B 2439/46; B32B 2307/518; B32B 2307/72; B32B 2307/7244; B32B 2307/7246; B32B 2255/205

(57) ABSTRACT

A multilayer structure includes an oriented polyethylene film and a barrier layer disposed on at least one surface of the oriented polyethylene film. The oriented polyethylene film comprises at least one layer having a polymer blend of at least one ethylene-based polymer and at least one ethylene acid copolymer. The ethylene-based polymer has a density of 0.910 to 0.960 g/cm³ and a melt index (I₂) of 0.3 to 10 g/10 mins. The ethylene acid copolymer is the polymerized reaction product of ethylene monomer, monomer selected from the group consisting of monocarboxylic acids, dicarboxylic acids, anhydrides, and monoesters thereof, and optionally alkyl acrylate monomer. From 0 to 90 mol. % of total acid units of the ethylene acid copolymer may be neutralized with a neutralizing salt solution.

### CROSS REFERENCE TO RELATED APPLICATIONS

This application claims priority to U.S. Provisional Patent Application No. 62/799,251, filed on Jan. 31, 2019, the entire disclosure of which is hereby incorporated by reference.

### FIELD

The present disclosure relates to multilayer structures, to articles comprising such multilayer structures, and to processes for manufacturing multilayer structures.

### BACKGROUND

Some packages such as food packages are designed to protect the contents from the external environment and to facilitate a longer shelf. Such packages are often constructed using barrier films with low oxygen transmission rates (OTR) and water vapor transmission rates (WVTR). However, in balancing the barrier properties, consideration is also given to package integrity to, for example, avoid leakage.

To make barrier films, a typical approach is to deposit metal layer on polymeric substrate films through vacuum metallization process. A thin coating of metal, often aluminum, can be used to provide barrier properties to polymeric films which may on their own lack resistance to the permeation of vapors and/or gases. In order to make such substrate film and gain a high quality metallized product, the substrate should have high stiffness, dimensional stability under tension, and a smooth surface for stable production and a glossy appearance. Typical metalized substrates include polypropylene (PP), biaxially oriented polypropylene (BOPP), and polyethylene terephthalate (PET). Polyethylene films are not widely used as substrates for metallization due to their inferior dimensional stability under tension especially in high-speed vacuum metallization processes. Additionally, some polymeric substrate films lack good adhesion to the barrier layer, which in turn reduces the barrier functionality of the film.

Due to their recyclability in existing recycling streams, there remains a need for polyethylene films with improved metal bonding properties.

### SUMMARY

Various embodiments described herein can provide good adhesion between the polyethylene substrate and a barrier layer, such as a metallized barrier layer.

According to various embodiments described herein, a multilayer structure includes an oriented polyethylene film and a barrier layer disposed on at least one surface of the oriented polyethylene film. The oriented polyethylene film comprises at least one layer having a polymer blend of at least one ethylene-based polymer and at least one ethylene acid copolymer. The ethylene-based polymer comprises ethylene α-olefin copolymer, ethylene homopolymer, or combinations thereof, wherein the ethylene based polymer has a density of 0.910 to 0.960 g/cm3 and a melt index (I2) of 0.3 to 10 g/10 mins. The ethylene acid copolymer is the polymerized reaction product of at least 50 wt. % ethylene monomer, from 1 to 30 wt. % of monomer selected from the group consisting of monocarboxylic acids, dicarboxylic acids, anhydrides, and monoesters thereof, and from 0 to 10 wt. % of alkyl acrylate monomer, based on the total wt. % of the monomers present in the ethylene acid copolymer. In various embodiments, from 0 to 90 mol. % of total acid units of the ethylene acid copolymer are neutralized with a neutralizing salt solution.

In another aspect, various embodiments relate to an article, such as a pouch, comprising any of the multilayer structures disclosed herein.

In another aspect, various embodiments related to a laminate comprising any of the multilayer structures disclosed herein adhered to a second film. The second film comprises polyethylene, polyamide, polyethylene terephthalate, polypropylene, or combinations thereof.

These and other embodiments are described in more detail in the Detailed Description.

### DETAILED DESCRIPTION

Unless stated to the contrary, implicit from the context, or customary in the art, all parts and percents are based on weight, all temperatures are in ° C., and all test methods are current as of the filing date of this disclosure.

The term “composition,” as used herein, refers to a mixture of materials which comprises the composition, as well as reaction products and decomposition products formed from the materials of the composition.

“Polymer” means a polymeric compound prepared by polymerizing monomers, whether of the same or a different type. The generic term polymer thus embraces the term homopolymer (employed to refer to polymers prepared from only one type of monomer, with the understanding that trace amounts of impurities can be incorporated into the polymer structure), and the term interpolymer as defined hereinafter. Trace amounts of impurities (for example, catalyst residues) may be incorporated into and/or within the polymer. A polymer may be a single polymer, a polymer blend or polymer mixture.

The term “interpolymer,” as used herein, refers to polymers prepared by the polymerization of at least two different types of monomers. The generic term interpolymer thus includes copolymers (employed to refer to polymers prepared from two different types of monomers), and polymers prepared from more than two different types of monomers.

The terms “olefin-based polymer” or “polyolefin”, as used herein, refer to a polymer that comprises, in polymerized form, a majority amount of olefin monomer, for example ethylene or propylene (based on the weight of the polymer), and optionally may comprise one or more comonomers.

“Polypropylene” or “propylene-based polymer” means a polymer having greater than 50 mole % units derived from propylene monomer. The term “polypropylene” includes homopolymers of propylene such as isotactic polypropylene, random copolymers of propylene and one or more C2, 4-8 α-olefins in which propylene comprises at least 50 mole percent, and impact copolymers of polypropylene.

The term “in adhering contact” and like terms mean that one facial surface of one layer and one facial surface of another layer are in touching and binding contact to one another such that one layer cannot be removed from the other layer without damage to the interlayer surfaces (i.e., the in-contact facial surfaces) of both layers.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

“Polyethylene” or “ethylene-based polymer” shall mean polymers comprising greater than 50% by mole of units which have been derived from ethylene monomer. This includes polyethylene homopolymers or copolymers (meaning units derived from two or more comonomers). The term, “ethylene/α-olefin copolymer,” as used herein, refers to a copolymer that comprises, in polymerized form, at least 50% by mole of ethylene monomer, and an α-olefin, as the only two monomer types. Common forms of polyethylene known in the art include Low Density Polyethylene (LDPE); Linear Low Density Polyethylene (LLDPE); Ultra Low Density Polyethylene (ULDPE); Very Low Density Polyethylene (VLDPE); single-site catalyzed Linear Low Density Polyethylene, including both linear and substantially linear low density resins (m-LLDPE); Medium Density Polyethylene (MDPE); and High Density Polyethylene (HDPE). These polyethylene materials are generally known in the art; however, the following descriptions may be helpful in understanding the differences between some of these different polyethylene resins. The term “ethylene-acid copolymer” refers to a copolymer that comprises, in polymerized form, at least 50 mole % ethylene monomer and an acid copolymer, such as methacrylic acid or acrylic acid.

The term “LLDPE”, includes both resin made using the traditional Ziegler-Natta catalyst systems as well as single-site catalysts, including, but not limited to, bis-metallocene catalysts (sometimes referred to as “m-LLDPE”) and constrained geometry catalysts, and includes linear, substantially linear or heterogeneous polyethylene copolymers or homopolymers. LLDPEs contain less long chain branching than LDPEs and include the substantially linear ethylene polymers which are further defined in U.S. Pat. Nos. 5,272,236, 5,278,272, 5,582,923 and 5,733,155; the homogeneously branched linear ethylene polymer compositions such as those in U.S. Pat. No. 3,645,992; the heterogeneously branched ethylene polymers such as those prepared according to the process disclosed in U.S. Pat. No. 4,076,698; and/or blends thereof (such as those disclosed in U.S. Pat. No. 3,914,342 or 5,854,045). The LLDPEs can be made via gas-phase, solution-phase or slurry polymerization or any combination thereof, using any type of reactor or reactor configuration known in the art.

The term “HDPE” refers to polyethylenes having densities greater than about 0.935 g/cm3, which are generally prepared with Ziegler-Natta catalysts, chrome catalysts or single-site catalysts including, but not limited to, bis-metallocene catalysts and constrained geometry catalysts.

The term “ionomer” refers to a copolymer including at least one acid-based monomer that has been at least partially neutralized by a metal-containing neutralizing agent.

In various embodiments, a multilayer structure comprises (a) an oriented polyethylene film comprising at least one layer that has a polymer blend of at least one ethylene-based polymer and at least one ethylene acid copolymer; and (b) a barrier layer disposed on at least one surface of the oriented polyethylene film. The ethylene-based polymer comprises ethylene α-olefin copolymer, ethylene homopolymer, or combinations thereof and has a density of from 0.910 to 0.960 g/cm3 and a melt index (I2) of 0.3 to 10 g/10 mins. The ethylene acid copolymer is the polymerized reaction product of at least 50 wt. % ethylene monomer, from 1 to 30 wt. % monomer selected from the group consisting of monocarboxylic acids, dicarboxylic acids, anhydrides, and monoesters thereof, and from 0 to 10 wt. % alkyl acrylate monomer, based on the total wt. % of the monomers present in the ethylene acid copolymer. In various embodiments, from 0 to 90 mol. % of total acid units of ethylene acid copolymer are neutralized with a neutralizing salt solution, and the oriented polyethylene film has a viscosity ratio of ethylene acid copolymer to ethylene-based polymer that is smaller than 1.

In some embodiments, the barrier layer is a gas and moisture barrier layer comprising metal-based materials, wherein the metal-based materials comprise Al, Si, Zn, Au, Ag, Cu, Ni, Cr, Ge, Se, Ti, Sn, oxides thereof, and combinations thereof.

In some embodiments, the metal is deposited on the oriented polyethylene film by vacuum metallization.

In some embodiments, the barrier layer comprises Al metal, oxides of Al, or both.

In some embodiments, the ethylene acid copolymer is an ionomer having 5 to 90 mole percent or 5 to 70 mole percent of total acid units neutralized by the neutralizing salt solution, and the neutralizing salt solution comprises Zn cations, Na cations, or combinations thereof.

In some embodiments, the monomer is selected from the group consisting of monocarboxylic acids, dicarboxylic acids, anhydrides, and monoesters thereof. In some embodiments including a monocarboxylic acid monomer, the monocarboxylic acid monomer comprises acrylic acid, methacrylic acid, or combinations thereof, and the alkyl acrylate monomer comprises methyl acrylate, ethyl acrylate, n-butyl acrylate or iso-butyl acrylate, or combinations thereof. Other suitable monomers include, but are not limited to, maleic acid, maleic anhydride, a C1-C4-alkyl half ester of maleic acid, fumaric acid, itaconic acid and itaconic anhydride.

In some embodiments, the ethylene acid copolymer comprises from 1 to 8 wt. % of alkyl acrylate monomer, based on the total wt. % of the monomers present in the ethylene acid copolymer.

In some embodiments, the ethylene-based polymer comprises linear low density polyethylene (LLDPE), high density polyethylene (HDPE), or combinations thereof.

In some embodiments, the melt index (I2) of the ethylene-based polymer is from 0.5 to 4 g/10 mins or from 0.3 to 1.1 g/10 mins.

In some embodiments, the barrier layer has a thickness of from 1 to 50 nm, and the oriented polyethylene film has a thickness of from 10 to 80 μm.

In some embodiments, the oriented polyethylene film comprises at least 99 wt. % ethylene acid copolymer and ethylene α-olefin copolymer or at least 70 wt. % ethylene acid copolymer and ethylene α-olefin copolymer.

In some embodiments, the polymer blend comprises from 3 to 40 wt. % ethylene acid copolymer and from 60 to 97 wt. % ethylene α-olefin copolymer.

In some embodiments, the oriented polyethylene film is a multilayer film, or a monolayer film. In some embodiments, the oriented polyethylene film is a biaxially oriented film. The biaxially oriented polyethylene film may be oriented in the machine direction at a draw ratio from 2:1 to 6:1 and in the cross direction at a draw ratio from 2:1 to 10:1.

In some embodiments, the oriented polyethylene film is a uniaxially or monoaxially oriented polyethylene film which is oriented in the machine direction.

A multilayer structure of the present disclosure can comprise a combination of two or more embodiments as described herein.

Embodiments also relate to articles such as packages or pouches. In some embodiments, an article can include any of the multilayer structures disclosed herein. An article can comprise a combination of two or more embodiments as described herein.

Embodiments also relate to laminates. In some embodiments, a laminate can include any of the multilayer structures disclosed herein adhered to a second film. The second film can comprise polyethylene, polyamide, polyethylene terephthalate, polypropylene or combinations thereof.

### Oriented Polyethylene Film

Multilayer structures of various embodiments comprise an oriented polyethylene film. The combination of the oriented polyethylene film with the barrier layer (discussed below), in some embodiments, advantageously provides improved adhesion between the oriented polyethylene film and the barrier layer.

The oriented polyethylene film comprises at least one layer that includes a polymer blend of at least one ethylene-based polymer and at least one ethylene acid copolymer. The ethylene-based polymer includes ethylene α-olefin copolymer, ethylene homopolymer, or combinations thereof. The ethylene-based polymer has a density of from 0.910 to 0.960 g/cm3 and a melt index (I2) of from 0.3 to 10 g/10 mins. In some embodiments, the ethylene-based polymer is linear low density polyethylene (LLDPE), high density polyethylene (HDPE), or combinations thereof.

The LLDPEs used in the ethylene-based polymer can include Ziegler-Natta catalyzed linear low density polyethylene, single site catalyzed (including metallocene) linear low density polyethylene, and high density polyethylene (HDPE) so long as the HDPE has a density no greater than 0.960 g/cm3, as well as combinations of two or more of the foregoing. All individual values and subranges greater than or equal to 0.960 g/cm3 are included herein and disclosed herein; for example, the density of the ethylene-based polymer can be from a lower limit of 0.910, 0.915, 0.920, 0.925, 0.928, 0.931 or 0.934 g/cm3. In some aspects, the ethylene-based polymer has a density less than or equal to 0.960 g/cm3. All individual values and subranges of less than 0.960 g/cm3 are included herein and disclosed herein; for example, the first linear low density polyethylene can have a density from an upper limit of 0.955, 0.950, 0.940, or 0.930 g/cm3. In some embodiments, the ethylene-based polymer has a density from 0.910 to 0.960 g/cm3.

The ethylene-based polymer has a melt index (I2) less than or equal to 10 g/10 minutes. All individual values and subranges from 10 g/10 minutes are included herein and disclosed herein. For example, the first linear low density polyethylene can have an 12 from an upper limit of 10, 9, 8, 7, 6, 5, 4, 3.5, 3, 3.5, 2, 1.9, 1.8, 1.7, 1.6, 1.5, 1.4, 1.3, 1.2, or 1.1 g/10 minutes. In a particular aspect, the first linear low density polyethylene has an 12 with a lower limit of 0.3 g/10 minutes. All individual values and subranges from 0.3 g/10 minutes are included herein and disclosed herein. For example, the first linear low density polyethylene can have an 12 greater than or equal to 0.3, 0.4, 0.45, or 0.5 g/10 minutes. The ethylene-based polymer used in the at least one layer can be characterized as having a melt index (I2) of from 0.3 to 10 g/10 mins, from 0.5 to 4 g/10 mins, or even from 0.3 to 1.1 g/10 mins.

In some embodiments, the polymer blend forming the at least one layer of the oriented polyethylene film comprises a significant amount of the ethylene-based polymer. In some embodiments, the polymer blend comprises at least 60 wt. % of the ethylene-based polymer, based on the weight of the polymer blend. The polymer blend comprises at least 70 wt. % of the ethylene-based polymer, based on the weight of polymer blend, in some embodiments. In some embodiments, the polymer blend comprises at least 80 wt. % of the ethylene-based polymer, based on the weight of polymer blend. In some embodiments, the polymer blend comprises at least 85 wt. % of the ethylene-based polymer, based on the weight of the polymer blend. The polymer blend comprises up to 97 wt. % of the ethylene-based polymer, based on the weight of the polymer blend in some embodiments.

In embodiments in which the ethylene-based polymer is an ethylene α-olefin copolymer, the polymer blend may comprise at least 60 wt. % of the ethylene α-olefin copolymer, based on the weight of the polymer blend. The polymer blend comprises at least 70 wt. % of the ethylene α-olefin copolymer, based on the weight of polymer blend, in some embodiments. In some embodiments, the polymer blend comprises at least 80 wt. % of the ethylene α-olefin copolymer, based on the weight of polymer blend. In some embodiments, the polymer blend comprises at least 85 wt. % of the ethylene α-olefin copolymer, based on the weight of the polymer blend. The polymer blend comprises up to 97 wt. % of the ethylene α-olefin copolymer, based on the weight of the polymer blend in some embodiments.

As described above, in various embodiments, the polymer blend further comprises an ethylene acid copolymer. The ethylene acid copolymer is the polymerized reaction product of ethylene monomer, a monomer selected from the group consisting of monocarboxylic acids, dicarboxylic acids, anhydrides, and monoesters thereof, and, optionally, alkyl acrylate monomer. In various embodiments, the ethylene monomer is included in an amount of at least 50 wt. % based on the total weight of the monomers present in the ethylene acid copolymer. For example, the ethylene monomer may be included in an amount of 50 wt. %, 60 wt. %, 70 wt. %, 75 wt. %, 80 wt. %, 85 wt. %, 90 wt. %, 95 wt. %, or even 98 wt. % based on the total weight of the monomers present in the ethylene acid copolymer. The ethylene monomer may be included in an amount of from 50 wt. % to 98 wt. %, 50 wt. % to 90 wt. %, 50 wt. % to 80 wt. %, or from 50 wt. % to 75 wt. %, for example.

In various embodiments, the monomer is selected from the group consisting of monocarboxylic acids, dicarboxylic acids, anhydrides, and monoesters thereof. The monocarboxylic acid monomer may be, for example, acrylic acid, methacrylic acid, or combinations thereof. The monomer is included in an amount of from 1 to 30 wt. % based on the total weight of the monomers present in the ethylene acid copolymer. For example, the polymerization reaction may include 2 wt. %, 5 wt. %, 10 wt. %, 15 wt. %, 20 wt. %, 25 wt. %, or even 30 wt. % monomer based on the total weight of the monomers present in the ethylene acid copolymer. The polymerization reaction may include from 1 to 30 wt. %, from 5 wt. % to 25 wt. %, or from 10 wt. % to 20 wt. % monomer based on the total weight of the monomers present in the ethylene acid copolymer.

In embodiments in which the ethylene acid copolymer is the reaction product of a mixture including alkyl acrylate monomer, the alkyl acrylate monomer may be methyl acrylate, ethyl acrylate, n-butyl acrylate or iso-butyl acrylate, or combinations thereof. The alkyl acrylate monomer may be included in amounts of from 0 to 10 wt. %, from greater than 0 to 10 wt. %, or from 1 to 8 wt. % of alkyl acrylate monomer, based on the total weight of the monomers present in the ethylene acid copolymer. For example, the alkyl acrylate monomer may be included in an amount of 1 wt. %, 2 wt. %, 3 wt. %, 4 wt. %, 5 wt. %, 6 wt. %, 7 wt. %, or 8 wt. % based on the total weight of the monomers present in the ethylene acid copolymer. The alkyl acrylate may be monomer may be included in amount of from 1 to 8 wt. %, from 2 to 7 wt. %, or from 3 to 6 wt. %, for example.

In various embodiments, the polymer blend includes from 3 to 40 wt. % ethylene acid copolymer. For example, the polymer blend may include 3 wt. %, 5 wt. %, 10 wt. %, 20 wt. %, 25 wt. %, 30 wt. %, or even 40 wt. % ethylene acid copolymer based on a total weight of the polymer blend. The polymer blend may include from 3 to 40 wt. % ethylene acid copolymer, from 5 to 30 wt. % ethylene acid copolymer, or from 10 to 25 wt. % ethylene acid copolymer, for example.

The ethylene acid copolymer may be neutralized with a neutralizing salt solution in some embodiments. For example, from 0 to 90 mole percent, from 0 to 70 mole percent, from 5 to 90 mole percent, or from 5 to 70 mole percent of the total acid units of the ethylene acid copolymer may be neutralized. In some embodiments, the ethylene acid copolymer is an ionomer having 5 mol. %, 10 mol. %, 20 mol. %, 30 mol. %, 40 mol. %, 50 mol. %, 60 mol. %, 70 mol. %, 80 mol. %, or even 90 mol. % of the total acid units neutralized by a neutralizing salt solution. The neutralizing salt solution may include, for example, Zn cations, Na cations, or combinations thereof.

In some embodiments, the layer of the oriented polyethylene film may contain one or more additives as is generally known in the art. Such additives include antioxidants, such as IRGANOX 1010 and IRGAFOS 168 (commercially available from BASF), ultraviolet light absorbers, antistatic agents, pigments, dyes, nucleating agents, fillers, slip agents, fire retardants, plasticizers, processing aids, lubricants, stabilizers, smoke inhibitors, viscosity control agents, surface modification agents, and anti-blocking agents. The layer composition may advantageously, for example, comprise less than 30 percent by the combined weight of one or more additives, based on the weight of the outer layer in some embodiments, and less than 10 percent by weight, less than 5 percent by weight or even less than 1 percent by weight in other embodiments. In other words, the layer may include at least 70 wt. % ethylene acid copolymer and ethylene-based polymer, at least 90 wt. % ethylene acid copolymer and ethylene-based polymer, at least 95 wt. % ethylene acid copolymer and ethylene-based polymer, or even 99 wt. % ethylene acid copolymer and ethylene-based polymer.

In one embodiment, the polyethylene film has a melt viscosity ratio of ethylene acid copolymer to ethylene-based polymer of that is smaller than 1. For example, the melt viscosity ratio can be from 0.05 to 1. Moreover, in some embodiments, the polyethylene film has a melt index ratio (I10/I2) of greater than 1. For example, the melt index ratio can be from 1 to 50.

In some embodiments, the oriented polyethylene film is a monolayer film such that the at least one layer is the only layer.

In some embodiments, the oriented polyethylene film is a multilayer film. For example, a multilayer film can further comprise other layers typically included in multilayer films depending on the application including, for example, sealant layers, barrier layers, tie layers, other polyethylene layers, etc. In some embodiments, the oriented polyethylene film may include at least 70 wt. % ethylene acid copolymer and ethylene-based polymer, at least 90 wt. % ethylene acid copolymer and ethylene-based polymer, at least 95 wt. % ethylene acid copolymer and ethylene-based polymer, or even 99 wt. % ethylene acid copolymer and ethylene-based polymer.

As one example, in some embodiments, a multilayer film can comprise another layer (Layer B, with Layer A being the previously discussed layer) having a top facial surface and a bottom facial surface, wherein the top facial surface of Layer B is in adhering contact with a bottom facial surface of Layer A.

In some such embodiments, Layer B can be a sealant layer formed from one or more ethylene-based polymers as known to those of skill in the art to be suitable for use in a sealant layer.

However, as noted above, Layer B can comprise any number of other polymers or polymer blends. For example, if the multilayer film includes a barrier layer, Layer B could be a tie layer in adhering contact between the outer layer and the barrier layer, and another tie layer could be between the barrier layer and a sealant layer.

Depending on the composition of the additional layer and the multilayer film, in some embodiments, the additional layer can be coextruded with other layers in the film.

It should be understood that any of the foregoing layers can further comprise one or more additives as known to those of skill in the art such as, for example, antioxidants, ultraviolet light stabilizers, thermal stabilizers, slip agents, antiblock, pigments or colorants, processing aids, crosslinking catalysts, flame retardants, fillers and foaming agents.

Such polyethylene films (whether monolayer or multilayer), prior to orientation, can have a variety of thicknesses depending, for example, on the number of layers, the intended use of the film, and other factors. Such polyethylene films, in some embodiments, have a thickness prior to orientation of 320 to 3200 microns (typically, 640-1920 microns).

Prior to orientation, the polyethylene films can be formed using techniques known to those of skill in the art based on the teachings herein. For example, the films can be prepared as blown films (e.g., water quenched blown films) or cast films. For example, in the case of multilayer polyethylene films, for those layers that can be coextruded, such layers can be coextruded as blown films or cast films using techniques known to those of skill in the art based on the teachings herein.

In some embodiments, the polyethylene film is oriented using a tenter frame sequential biaxial orientation process. Such techniques are generally known to those of skill in the art. In other embodiments, the polyethylene film can be oriented using other techniques known to those of skill in the art based on the teachings herein, such as double bubble orientation processes, triple bubble orientation process, simultaneous biaxial orientation process, or even monoaxial orientation process. In general, with a tenter frame sequential biaxial orientation process, the tenter frame is incorporated as part of a multilayer co-extrusion line. After extruding from a flat die, the film is cooled down on a chill roll, and is immersed into a water bath filled with room temperature water. The cast film is then passed onto a series of rollers with different revolving speeds to achieve stretching in the machine direction. There are several pairs of rollers in the MD stretching segment of the fabrication line, and are all oil heated. The paired rollers work sequentially as pre-heated rollers, stretching rollers, and rollers for relaxing and annealing. The temperature of each pair of rollers is separately controlled. After stretching in the machine direction, the film web is passed into a tenter frame hot air oven with heating zones to carry out stretching in the cross direction. The first several zones are for pre-heating, followed by zones for stretching, and then the last zones for annealing.

Without wishing to be bound by any particular theory, it is believed that the biaxial orientation of the polyethylene film specified herein provides increased modulus and high ultimate strength which facilitates deposition of the metal layer (at high speeds, in some embodiments) and provides an improved glossy appearance. However, uniaxially oriented or monoaxially oriented polyethylene films are also contemplated. Such films may be oriented, for example in the machine direction.

In some embodiments, the polyethylene film can be oriented in the machine direction at a draw ratio of 2:1 to 6:1, or in the alternative, at a draw ratio of 3:1 to 5:1. The polyethylene film, in some embodiments, can be oriented in the cross direction at a draw ratio of 2:1 to 10:1, or in the alternative, at a draw ratio of 3:1 to 8:1. In some embodiments, the polyethylene film is oriented in the machine direction at a draw ratio of 2:1 to 6:1 and in the cross direction at a draw ratio of 2:1 to 10:1. The polyethylene film, in some embodiments, is oriented in the machine direction at a draw ratio of 3:1 to 5:1 and in the cross direction at a draw ratio of 3:1 to 8:1.

In some embodiments, the ratio of the draw ratio in the machine direction to the draw ratio in the cross direction is from 1:1 to 1:2.5. In some embodiments, the ratio of the draw ratio in the machine direction to the draw ratio in the cross direction is from 1:1.5 to 1:2.0.

In some embodiments, the biaxially oriented polyethylene film has an overall draw ratio (draw ratio in machine direction X draw ratio in cross direction) of 8 to 54. The biaxially oriented polyethylene film, in some embodiments, has an overall draw ratio (draw ratio in machine direction X draw ratio in cross direction) of 9 to 40.

After orientation, the oriented film has a thickness of 10 to 80 microns in some embodiments. In some embodiments, the oriented film has a thickness of 20 to 50 microns.

In some embodiments, depending for example on the end use application, the oriented polyethylene film can be corona treated, plasma treated, or printed using techniques known to those of skill in the art.

Following orientation, the oriented polyethylene films are then provided with a barrier layer on the layer comprising the polymer blend described above.

### Barrier Layer

In various embodiments, the barrier layer is a gas and moisture barrier layer including metal-based materials. Accordingly, in some embodiments described herein, the barrier layer may be referred to as a “metal layer.”

The metal layer is applied to the oriented polyethylene film using vacuum metallization. Vacuum metallization is a well-known technique for depositing metals in which a metal source is evaporated in a vacuum environment, and the metal vapor condenses on the surface of the film to form a thin layer as the film passes through the vacuum chamber. In various embodiments, the barrier layer has a thickness of from 1 nm to 50 nm. For example, the barrier layer may have a thickness of 1 nm, 5 nm, 10 nm, 20 nm, 25 nm, 30 nm, 40 nm, or even 50 nm.

The metals that can be deposited on the oriented polyethylene film include Al, Si, Zn, Au, Ag, Cu, Ni, Cr, Ge, Se, Ti, Sn, oxides thereof, or combinations thereof. In some embodiments, the metal layer is formed from aluminum or aluminum oxide (Al₂O₃).

### Multilayer Structures

Multilayer structures of the present disclosure, in some embodiments, comprise an oriented polyethylene film and a metal layer deposited thereon (as described above). The combination of oriented polyethylene film with the metal layer deposited on the specified outer surface can provide a synergistic combination of both mechanical and barrier properties. The multilayer structures, in some embodiments, can also have acceptable stiffness, good optical properties, puncture/dart drop resistance, tear resistance, and low temperature sealing performance.

### Articles

Multilayer structures of various embodiments described herein can be used to form articles such as packages or laminates. Such articles can be formed from any of the multilayer structures described herein.

Examples of packages that can be formed from multilayer structures of various embodiments can include flexible packages, pouches, stand-up pouches, and pre-made packages or pouches. In some embodiments, multilayer films of the present disclosure can be used for food packages. Examples of food that can be included in such packages include meats, cheeses, cereal, nuts, juices, sauces, and others. Such packages can be formed using techniques known to those of skill in the art based on the teachings herein and based on the particular use for the package (e.g., type of food, amount of food, etc.).

Laminates may include the multilayer structures of various embodiments adhere to one or more additional films. For example, a multilayer structure of one or more embodiments described hereinabove may be adhered to a second film. The second film may include, for example, polyethylene, polyamide, polyethylene terephthalate, polypropylene, or combinations thereof. The multilayer structure may be adhered to the second film through an adhesive layer, as may be known in the art.

It is further noted that terms like “generally,” commonly,” and “typically” are not utilized herein to limit the scope of the claims or to imply that certain features are critical, essential, or even important to the structure of function of various embodiments. Rather, these terms are merely intended to highlight alternative or additional features that may or may not be utilized in particular embodiments of the present disclosure.

It will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these aspects.

1. A multilayer structure comprising:
an oriented polyethylene film comprising at least one layer having a polymer blend of at least one ethylene-based polymer and at least one ethylene acid copolymer, wherein:
the ethylene-based polymer comprises ethylene α-olefin copolymer, ethylene homopolymer, or combinations thereof, wherein the ethylene-based polymer has a density of from 0.910 to 0.960 g/cm³ and a melt index (I₂) of 0.3 to 10 g/10 mins;
the ethylene acid copolymer is the polymerized reaction product of:
at least 50 wt. % ethylene monomer, based on the total weight of the monomers present in the ethylene acid copolymer;
from 1 to 30 wt. % of monomer selected from the group consisting of monocarboxylic acids, dicarboxylic acids, anhydrides, and monoesters thereof, based on the total weight of the monomers present in the ethylene acid copolymer; and
from 0 to 10 wt. % of alkyl acrylate monomer, based on the total weight of the monomers present in the ethylene acid copolymer; and
0 to 90 mole percent of total acid units of the ethylene acid copolymer are neutralized with a neutralizing salt solution; and
a barrier layer disposed on at least one surface of the oriented polyethylene film.

2. The multilayer structure of claim 1, wherein the oriented film is a biaxially oriented polyethylene film.

3. The multilayer structure of claim 2, wherein the biaxially oriented polyethylene film is oriented in the machine direction at a draw ratio from 2:1 to 6:1 and in the cross direction at a draw ratio from 2:1 to 10:1.

4. The multilayer structure of claim 1, wherein the oriented film is a uniaxially oriented polyethylene film which is oriented in the machine direction.

5. The multilayer structure of claim 1, wherein the barrier layer is a gas and moisture barrier layer comprising metal-based materials, wherein the metal-based materials comprise Al, Si, Zn, Au, Ag, Cu, Ni, Cr, Ge, Se, Ti, Sn, oxides thereof, and combinations thereof.

6. The multilayer structure of claim 5, wherein the metal-based material comprises Al metal, oxides of Al, or both.

7. The multilayer structure of claim 5, wherein the metal-based material is deposited on the oriented polyethylene film by vacuum metallization.

8. The multilayer structure of claim 1, wherein the ethylene acid copolymer is an ionomer having 5 to 70 mole percent of total acid units neutralized by the neutralizing salt solution, and wherein the neutralizing salt solution comprises Zn cations, Na cations, or combinations thereof.

9. The multilayer structure of claim 1, wherein the monomer selected from the group consisting of monocarboxylic acids, dicarboxylic acids, anhydrides, and monoesters thereof comprises acrylic acid, methacrylic acid, or combinations thereof, and wherein the alkyl acrylate monomer comprises methyl acrylate, ethyl acrylate, n-butyl acrylate or iso-butyl acrylate, or combinations thereof.

10. The multilayer structure of claim 1, wherein the ethylene acid copolymer comprises from 1 to 8 wt. % of alkyl acrylate monomer, based on the total wt. % of the monomers present in the ethylene acid copolymer.

11. The multilayer structure of claim 1, wherein the ethylene-based polymer comprises linear low density polyethylene (LLDPE), high density polyethylene (HDPE), or combinations thereof.

12. The multilayer structure of claim 1, wherein the melt index (I₂) of the ethylene-based polymer is from 0.5 to 4 g/10 mins.

13. The multilayer structure of claim 1, wherein the barrier layer has a thickness of from 1 to 50 nm, and the oriented polyethylene film has a thickness of from 10 to 80 μm.

14. The multilayer structure of claim 1, wherein the oriented polyethylene film comprises at least 99 wt. % ethylene acid copolymer and ethylene α-olefin copolymer.

15. The multilayer structure of claim 1, wherein the polymer blend comprises from 3 to 40 wt. % ethylene acid copolymer and from 60 to 97 wt. % ethylene α-olefin copolymer.

16. The multilayer structure of claim 1, wherein the oriented polyethylene film is a multilayer film, or a monolayer film, and wherein the oriented polyethylene film is oriented in the machine direction at a draw ratio from 2:1 to 6:1 and in the cross direction at a draw ratio from 2:1 to 10:1.

17. An article comprising the multilayer structure of claim 1, wherein the article is a pouch.

18. A laminate comprising the multilayer structure of claim 1 adhered to a second film, wherein the second film comprises polyethylene, polyamide, polyethylene terephthalate, polypropylene or combinations thereof.
